(19) United States
(12) Patent Application Publication
(10) Pub. No.: US 2023/0207871 A1
(43) Pub. Date: Jun. 29, 2023

(54) NONAQUEOUS ELECTROLYTE SECONDARY BATTERY POROUS LAYER

(71) Applicant: Sumitomo Chemical Company, Limited, Tokyo (JP)

(72) Inventors: Kensaku HORIE, Niihama-shi (JP); Makoto FURUKAWA, Niihama-shi (JP); Tomoaki OZEKI, Niihama-shi (JP); Hiroaki KUWABARA, Niihama-Shi (JP)

(21) Appl. No.: 18/075,772

(22) Filed: Dec. 6, 2022

(30) Foreign Application Priority Data
Dec. 7, 2021 (JP) 2021198754

(51) Int. Cl. H01M 10/0565; H01M 50/417; H01M 50/491

(52) U.S. Cl. CPC H01M 10/0565; H01M 50/417; H01M 50/491; H01M 2300/0082

(57) ABSTRACT

As a nonaqueous electrolyte secondary battery porous layer which can improve battery performance such as initial charge-discharge efficiency of a nonaqueous electrolyte secondary battery, provided is a nonaqueous electrolyte secondary battery porous layer which contains a resin that has an amide bond and that contains a cyclic component, and in which a contained amount of the cyclic component is not less than 2.0% by weight and not more than 10.0% by weight relative to a total weight of the resin having the amide bond.

### TECHNICAL FIELD

The present invention relates to a porous layer for a nonaqueous electrolyte secondary battery (hereinafter, referred to as a “nonaqueous electrolyte secondary battery porous layer”).

### BACKGROUND ART

Nonaqueous electrolyte secondary batteries, particularly lithium-ion secondary batteries, have high energy densities, and are thus in wide use as batteries for personal computers, mobile telephones, portable information terminals, and the like. Recently, such nonaqueous electrolyte secondary batteries have been developed as batteries for vehicles.

The end-of-charge voltages of conventional nonaqueous electrolyte secondary batteries are approximately 4.1 V to 4.2 V (4.2 V to 4.3 V (vs Li/Li⁺) as voltages relative to the electric potentials of lithium reference electrodes). In contrast, the end-of-charge voltages of recent nonaqueous electrolyte secondary batteries are increased to not less than 4.3 V, which is higher than those of the conventional nonaqueous electrolyte secondary batteries, so that the utilization rates of positive electrodes are increased and thereby the capacities of batteries are increased. For this purpose, it is important that resins contained in nonaqueous electrolyte secondary battery porous layers do not change in quality even when the resins are placed under high-voltage conditions.

Patent Literature 1 is one of documents which disclose resins having such a property. Patent Literature 1 discloses a wholly aromatic polyamide in which aromatic rings located at the respective terminals of its molecular chain each does not have an amino group and in which one or more aromatic rings each have an electron-withdrawing substituent. According to Patent Literature 1, the wholly aromatic polyamide hardly changes in color even when the wholly aromatic polyamide receives a high voltage.

### CITATION LIST

### Patent Literature

[Patent Literature 1]
Japanese Patent Application Publication Tokukai No. 2003-40999

### SUMMARY OF INVENTION

### Technical Problem

However, a nonaqueous electrolyte secondary battery porous layer which contains the resin as disclosed in Patent Literature 1 has room for improvement in terms of inhibiting or preventing a decrease in battery performance such as initial charge-discharge efficiency which results from oxidative deterioration that can occur when a charge-discharge cycle is carried out.

### Solution to Problem

The inventors of the present invention have found, as a result of diligent study, that a cyclic component produced as a by-product during production of a resin having an amide bond, which constitutes a nonaqueous electrolyte secondary battery porous layer, surprisingly functions to prevent oxidative deterioration of the nonaqueous electrolyte secondary battery porous layer and to improve initial charge-discharge efficiency of a nonaqueous electrolyte secondary battery, and conceived of the present invention.

The present invention has aspects described in <1> through <7> below.

<1> A nonaqueous electrolyte secondary battery composition containing at least one type of a resin having an amide bond, the resin having the amide bond containing a cyclic component, and a contained amount of the cyclic component being not less than 2.0% by weight and not more than 10.0% by weight relative to a total weight of the resin having the amide bond.
<2> A nonaqueous electrolyte secondary battery porous layer containing at least one type of a resin having an amide bond, the resin having the amide bond containing a cyclic component, and a contained amount of the cyclic component being not less than 2.0% by weight and not more than 10.0% by weight relative to a total weight of the resin having the amide bond.
<3> The nonaqueous electrolyte secondary battery porous layer described in <2>, in which: at least one type of the resin having the amide bond is a block copolymer including a block A containing, as a main component, units each represented by Formula (1) below, and a block B containing, as a main component, units each represented by Formula (2) below.

—(NH—Ar¹—NHCO—Ar²—CO)— Formula (1):

—(NH—Ar³—NHCO—Ar⁴—CO)— Formula (2):

In Formulae (1) and (2): Ar¹, Ar², Ar³, and Ar⁴ may each vary from unit to unit; Ar¹, Ar², Ar³, and Ar⁴ are each independently a divalent group having one or more aromatic rings; not less than 50% of all Ar¹ each have a structure in which two aromatic rings are connected by a sulfonyl bond; not more than 50% of all Ar³ each have a structure in which two aromatic rings are connected by a sulfonyl bond; and 10% to 70% of all Ar¹ and Ar³ each have a structure in which two aromatic rings are connected by a sulfonyl bond.

<4> The nonaqueous electrolyte secondary battery porous layer described in <2> or <3>, further containing a filler, a contained amount of the filler being not less than 20% by weight and not more than 90% by weight relative to a total weight of the nonaqueous electrolyte secondary battery porous layer.
<5> A nonaqueous electrolyte secondary battery laminated separator including: a polyolefin porous film; and the nonaqueous electrolyte secondary battery porous layer described in any one of <2> through <4>, the nonaqueous electrolyte secondary battery porous layer being formed on one surface or both surfaces of the polyolefin porous film.
<6> A nonaqueous electrolyte secondary battery member, including a positive electrode, the nonaqueous electrolyte secondary battery porous layer described in any one of <2> through <4> or the nonaqueous electrolyte secondary battery laminated separator described in <5>, and a negative electrode which are disposed in this order.
<7> A nonaqueous electrolyte secondary battery including: the nonaqueous electrolyte secondary battery porous layer described in any one of <2> through <4>; or the nonaqueous electrolyte secondary battery laminated separator described in <5>.

### Advantageous Effects of Invention

A composition for a nonaqueous electrolyte secondary battery (hereinafter, referred to as a “nonaqueous electrolyte secondary battery composition”) in accordance with an embodiment of the present invention brings about an effect of forming a nonaqueous electrolyte secondary battery porous substance which can improve initial charge-discharge efficiency of a nonaqueous electrolyte secondary battery. The nonaqueous electrolyte secondary battery porous substance in accordance with an embodiment of the present invention brings about an effect of improving initial charge-discharge efficiency of a nonaqueous electrolyte secondary battery.

### DESCRIPTION OF EMBODIMENTS

The following description will discuss embodiments of the present invention. Note, however, that the present invention is not limited to the embodiments. The present invention is not limited to arrangements described below, but may be altered in various ways by a skilled person within the scope of the claims. The present invention also encompasses, in its technical scope, any embodiment derived by appropriately combining technical means disclosed in differing embodiments. Note that a numerical range “A to B” herein means “not less (lower) than A and not more (higher) than B” unless otherwise stated.

### Embodiment 1: Nonaqueous Electrolyte Secondary Battery Composition, and Embodiment 2: Nonaqueous Electrolyte Secondary Battery Porous Layer

A nonaqueous electrolyte secondary battery composition in accordance with Embodiment 1 of the present invention (hereinafter simply referred to also as “composition”) is a nonaqueous electrolyte secondary battery composition containing at least one type of a resin having an amide bond, the resin having the amide bond containing a cyclic component, and a contained amount of the cyclic component being not less than 2.0% by weight and not more than 10.0% by weight relative to a total weight of the resin having the amide bond.

A nonaqueous electrolyte secondary battery porous layer in accordance with Embodiment 2 of the present invention (hereinafter simply referred to also as “porous layer”) is a nonaqueous electrolyte secondary battery porous layer containing at least one type of a resin having an amide bond, the resin having the amide bond containing a cyclic component, and a contained amount of the cyclic component being not less than 2.0% by weight and not more than 10.0% by weight relative to a total weight of the resin having the amide bond. The porous layer in accordance with Embodiment 2 of the present invention can be a porous layer which is formed by using, as a raw material thereof, the composition in accordance with Embodiment 1 of the present invention. In the descriptions below, the porous layer which is formed by using, as a raw material thereof, the composition in accordance with Embodiment 1 of the present invention and the porous layer in accordance with Embodiment 2 of the present invention are both referred to also as a “porous layer in accordance with an embodiment of the present invention”.

<Resin Having Amide Bond>

The composition in accordance with an embodiment of the present invention and the porous layer in accordance with an embodiment of the present invention each contain at least one type of a resin having an amide bond. The resin having an amide bond may be one type of resin or a mixture of two or more types of resins.

The resin having an amide bond has a structure in which divalent groups are connected by chemical bonds and at least one of the chemical bonds is an amide bond. The resin having an amide bond contains a cyclic component. In other words, the resin having an amide bond is, at least in part, a cyclic component. The cyclic component has no terminals. The resin having an amide bond can contain the cyclic component and a chain component having a terminal, i.e., a chain polymer.

Specifically, the resin having an amide bond can be prepared by a polymerization method in which the divalent groups are sequentially connected to each other through the chemical bonds. Therefore, the resin having an amide bond that is obtained by the preparation method can contain a chain polymer. Meanwhile, an intermediate product is produced during the preparation of the resin having an amide bond. The intermediate product has a smaller number of the divalent groups and the chemical bonds than the obtained chain polymer. Here, when both terminals of the same molecule in the intermediate product condense, the cyclic component is produced. Thus, the resin having an amide bond can contain the cyclic component and the chain polymer.

As described above, in an embodiment of the present invention, the cyclic component is produced from an intermediate product which has a smaller number of the divalent groups and the chemical bonds than the chain polymer. Therefore, the cyclic component has a smaller number of the divalent groups and the chemical bonds than the chain polymer. Accordingly, a weight-average molecular weight of the cyclic component is smaller than a weight-average molecular weight of the chain polymer.

Specifically, in an embodiment of the present invention, a molecular weight of the chain polymer, in terms of intrinsic viscosity, is preferably 0.5 dL/g to 5.0 dL/g, more preferably 1.0 dL/g to 3.5 dL/g, and further preferably 1.4 dL/g to 2.5 dL/g. Moreover, in an embodiment of the present invention, a molecular weight of the polymer constituting the cyclic component, in terms of intrinsic viscosity, is preferably 0.5 dL/g to 3.0 dL/g, and more preferably 0.7 dL/g to 1.5 dL/g.

In an embodiment of the present invention, it is possible to separate the chain polymer from the cyclic component in the resin having an amide bond, and to calculate a contained amount of the cyclic component, by utilizing the above described fact that the weight-average molecular weight estimated from the intrinsic viscosity of the chain polymer is different from the weight-average molecular weight estimated from the intrinsic viscosity of the cyclic component.

In the resin having an amide bond, the amide bond accounts for preferably 45% to 85% and more preferably 55% to 75% of the chemical bonds, from the viewpoint of heat resistance of the porous layer.

The divalent groups are not particularly limited. In an embodiment of the present invention, the divalent groups preferably include a divalent aromatic group, and more preferably all of the divalent groups are divalent aromatic groups. The divalent groups may be one type of group or may be two or more types of groups.

In this specification, a “divalent aromatic group” indicates a divalent group that contains an unsubstituted aromatic ring or a substituted aromatic ring, and preferably indicates a divalent group which is constituted by an unsubstituted aromatic ring or a substituted aromatic ring. An “aromatic ring” indicates a cyclic compound which satisfies the Hückel's rule. Examples of the aromatic ring include benzene, naphthalene, anthracene, azulene, pyrrole, pyridine, furan, and thiophene. In an embodiment of the present invention, the aromatic ring is composed solely of carbon atoms and hydrogen atoms. In an embodiment of the present invention, the aromatic ring is a benzene ring or a condensed ring derived from two or more benzene rings (such as naphthalene and anthracene).

In an embodiment of the present invention, a substituent in the divalent group is not particularly limited. In an embodiment of the present invention, the substituent in the divalent group is preferably an electron-withdrawing substituent from the viewpoint of obtaining a nonaqueous electrolyte secondary battery porous layer which is less prone to change in quality even under a high-voltage condition and which has high-voltage resistance. The electron-withdrawing substituent is not particularly limited. Examples of the electron-withdrawing substituent include a carboxyl group, an alkoxycarbonyl group, a nitro group, a halogen atom, and the like.

The chemical bonds may be only amide bonds or may include a bond different from the amide bond. The bond different from the amide bond is not particularly limited. Examples of the bond different from the amide bond include sulfonyl bonds, alkenyl bonds (e.g., C1-C5 alkenyl bonds), ether bonds, ester bonds, imide bonds, ketone bonds, sulfide bonds, and the like. The bond different from the amide bond may be one type of bond or may be two or more types of bonds.

In an embodiment of the present invention, it is preferable that the bond different from the amide bond includes a bond which has stronger electron-withdrawing property than the amide bond, from the viewpoint of obtaining a porous layer having high-voltage resistance. From the viewpoint of further improving the high-voltage resistance of the porous layer, a proportion of the bond which has the stronger electron-withdrawing property than the amide bond in the chemical bonds is more preferably 15% to 35% and further preferably 25% to 35%.

Examples of the bond having the stronger electron-withdrawing property than the amide bond include sulfonyl bonds, ester bonds, and the like among the above listed chemical bonds.

Specific examples of the resin having an amide bond include: polyamides; polyamide imides; and a copolymer of polyamide or polyamide imide and a polymer having one or more bonds which are selected from sulfonyl bonds, ether bonds, and ester bonds. The copolymer may be a block copolymer or may be a random copolymer.

The polyamides are preferably aromatic polyamides. Examples of the aromatic polyamides include wholly aromatic polyamides (aramid resins) and semi-aromatic polyamides. The aromatic polyamides are preferably wholly aromatic polyamides. Examples of the aromatic polyamides include para-aramids and meta-aramids.

The polyamide imides are preferably aromatic polyamide imides. Examples of the aromatic polyamide imides include wholly aromatic polyamide imides and semi-aromatic polyamide imides. The aromatic polyamide imides are preferably wholly aromatic polyamide imides.

Examples of the polymer which constitutes the copolymer and which has one or more bonds selected from the sulfonyl bonds, the ether bonds, and the ester bonds include polysulfone, polyether, polyester, and the like.

The resin having an amide bond is preferably a resin including a portion having flexibility. Examples of the portion having flexibility include an aromatic ring having an amide bond at a meta position, a sulfonyl bond, an ether bond, an ester bond, and the like. In a case where the resin having an amide bond contains the portion having flexibility, in the method of preparing the resin having an amide bond, both terminals of the same molecule in the intermediate product are easily brought closer to each other. As a result, both terminals of the intermediate product are easily condensed, and accordingly a suitable amount of the cyclic component is easily produced.

The resin containing a portion having flexibility is not particularly limited. Examples of the resin include a wholly aromatic polyamide-based resin containing, as a main component, units each represented by Formula (3) below, meta-aramid, and the like. Note that the phrase “main component” means that, among all units contained in the wholly aromatic polyamide-based resin, the units each represented by Formula (3) account for not less than 50%, preferably not less than 80%, more preferably not less than 90%, and further preferably not less than 95%.

—(NH—Ar⁵—NHCO—Ar⁶—CO)— Formula (3):

In Formula (3), Ar⁵ and Ar⁶ may each vary from unit to unit. Ar⁵ and Ar⁶ are each independently a divalent group having one or more aromatic rings.

Not less than 50% of all Ar⁵ each have a structure in which two aromatic rings are connected by a sulfonyl bond. The lower limit of the proportion of Ar⁵ having this structure is more preferably not less than 60% and further preferably not less than 80% of all Ar⁵. Examples of —Ar⁵— having such a structure include 4,4′-diphenylsulfonyl, 3,4′-diphenylsulfonyl, and 3,3′-diphenylsulfonyl.

Examples of —Ar⁵— not having the structure in which two aromatic rings are connected by a sulfonyl bond and —Ar⁶— include the following.

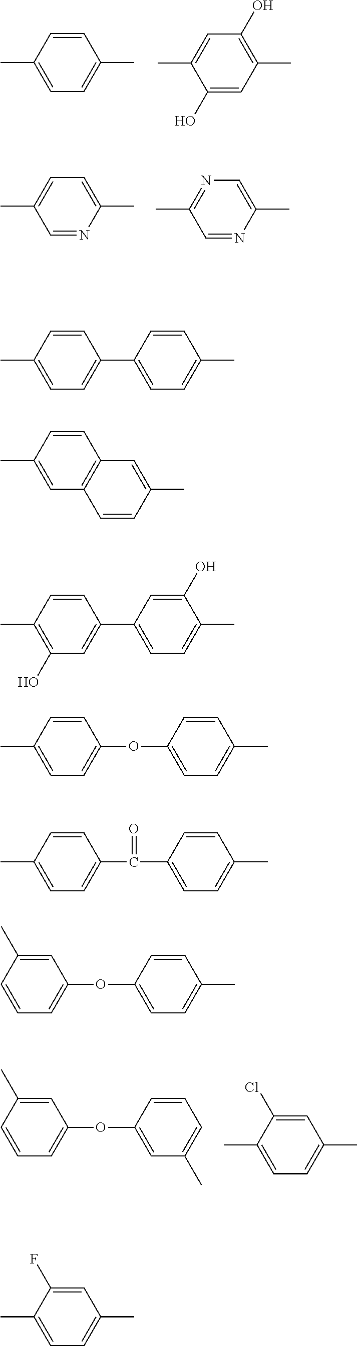

In an embodiment of the present invention, —Ar⁵— having the structure in which two aromatic rings are connected by a sulfonyl bond is 4,4′-diphenylsulfonyl. In an embodiment of the present invention, —Ar⁵— not having the structure in which two aromatic rings are connected by a sulfonyl bond and —Ar⁶— are paraphenyl.

In an embodiment of the present invention, the wholly aromatic polyamide-based resin containing, as a main component, units each represented by Formula (3) is, for example, an aromatic polyamide having (i) diamine units each derived from 4,4′-diaminodiphenylsulfone and paraphenylenediamine and (ii) dicarboxylic acid units each derived from terephthalic acid (or halogenated terephthalic acid). In another embodiment of the present invention, the wholly aromatic polyamide-based resin containing, as a main component, units each represented by Formula (3) is an aromatic polyamide having (i) diamine units each derived from 4,4′-diaminodiphenylsulfone and (ii) dicarboxylic acid units each derived from terephthalic acid (or halogenated terephthalic acid). Monomers contained in these units are readily available, and also these units are easy to handle.

The wholly aromatic polyamide-based resin which contains, as a main component, the units each represented by Formula (3) may have a structure which is composed of units other than the units each represented by Formula (3). Examples of such a structure include a polyimide backbone.

The wholly aromatic polyamide-based resin containing, as a main component, units each represented by Formula (3) may be used alone, or two or more types of the wholly aromatic polyamide-based resins may be alternatively used in combination.

The wholly aromatic polyamide-based resin containing, as a main component, units each represented by Formula (3) can be synthesized according to a conventional method. For example, the wholly aromatic polyamide-based resin containing, as a main component, units each represented by Formula (3) can be synthesized by polymerizing a diamine represented by NH₂—Ar⁵—NH₂ and a dicarboxylic dihalide represented by X—C(═O)—Ar⁶—C(═O)—X (X is a halogen atom such as F, Cl, Br, and I), according to a publicly known polymerization method for forming an aromatic polyamide.

A method of preparing the wholly aromatic polyamide-based resin containing, as a main component, units each represented by Formula (3) can be, for example, a method including the following steps (a) and (b).

(a) Diamine represented by NH₂—Ar⁵—NH₂ (where Ar⁵ is a group having a structure in which two aromatic rings are connected by a sulfonyl bond) and a dicarboxylic dihalide represented by X—C(═O)—Ar⁶—C(═O)—X are polymerized to obtain an intermediate product A.

(b) The intermediate product A obtained in the step (a), diamine which is represented by NH₂—Ar⁵—NH₂ and which is different from the diamine used in the step (a), and a dicarboxylic dihalide represented by X—C(═O)—Ar⁶—C(═O)—X are polymerized to prepare a wholly aromatic polyamide-based resin containing, as a main component, units each represented by Formula (3).

Note, here, that the sulfonyl bond has flexibility. Therefore, when the intermediate product A is produced, the cyclic component is produced as a by-product. In the step (a), by decreasing a concentration of the diamine and the dicarboxylic dihalide in the solvent, a condensation reaction is more likely to occur between both terminals of the same molecule than a condensation reaction between different molecules in a process in which the polymer extends. Therefore, the cyclic component is easily produced.

In an embodiment of the present invention, a concentration of the intermediate product A obtained in the step (a) is preferably 0.5% by weight to 10.0% by weight, and more preferably 1.0% by weight to 7.0% by weight. Controlling the concentration of the intermediate product A to fall within the above range means that the concentration of the diamine and the dicarboxylic dihalide in the solvent used for the reaction is decreased. In this manner, the cyclic component is easily produced, and as a result, a contained amount of the cyclic component in the resulting resin having an amide bond can be controlled to a suitable range of not less than 2.0% by weight and not more than 10.0% by weight.

Moreover, in an embodiment of the present invention, the contained amount of the cyclic component can be controlled by adding another cyclic component. In a case where the cyclic component obtained in the step (a) is subjected to extraction and purification, and is then mixed with the resin obtained in the step (b), the contained amount of the cyclic component can be controlled to fall within the suitable range, and a similar effect can be achieved.

The meta-aramid represents a wholly aromatic polyamide having an aromatic ring having an amide bond at a meta position. Specific examples of the meta-aramid include poly(metaphenylene terephthalamide), poly(metaphenylene isophthalamide), and the like. Among the above meta-aramids, poly(metaphenylene terephthalamide) is more preferable from the viewpoint of making it easier to produce the cyclic component. The meta-aramid may be used alone or two or more of the meta-aramids may be alternatively used in combination.

Examples of the resin having an amide bond include a block copolymer including a block A containing, as a main component, units each represented by Formula (1) below, and a block B containing, as a main component, units each represented by Formula (2) below.

—(NH—Ar¹—NHCO—Ar²—CO)— Formula (1):

—(NH—Ar³—NHCO—Ar⁴—CO)— Formula (2):

where: Ar¹, Ar², Ar³, and Ar⁴ may each vary from unit to unit; Ar¹, Ar², Ar³, and Ar⁴ are each independently a divalent group having one or more aromatic rings; not less than 50% of all Ar¹ each have a structure in which two aromatic rings are connected by a sulfonyl bond; not more than 50% of all Ar³ each have a structure in which two aromatic rings are connected by a sulfonyl bond; and 10% to 70%, preferably 10% to 50% of all Ar¹ and Ar³ each have a structure in which two aromatic rings are connected by a sulfonyl bond.

Here, in the block copolymer, it is preferable that: not less than 50% of the units which are contained in the block A and which are each represented by Formula (1) are each 4,4′-diphenylsulfonyl terephthalamide; and not less than 50% of the units which are contained in the block B and which are each represented by Formula (2) are each paraphenylene terephthalamide. Moreover, the block copolymer preferably has a triblock structure of the block B-the block A-the block B. Furthermore, it is preferable that: in a molecule corresponding to a mode in a molecular weight distribution of the block copolymer, the block A contains 10 to 1000 units each represented by Formula (1), and the block B contains 10 to 500 units each represented by Formula (2).

Another example of the resin having an amide bond is a polymer which does not contain units each represented by Formula (1) but contains 5 to 200 units each represented by Formula (2).

A resin constituting a conventional nonaqueous electrolyte secondary battery porous layer contains a chain polymer and does not contain a cyclic component or contains an extremely small amount of a cyclic component. In the chain polymer, terminal groups are easily oxidized. Therefore, groups at the terminals of the chain polymer are oxidized, and this causes oxidative deterioration in a porous layer containing the chain polymer. Accordingly, in a conventional nonaqueous electrolyte secondary battery, there are cases where cycle characteristics (e.g., initial charge-discharge efficiency and the like) are reduced due to the oxidative deterioration.

In contrast, in an embodiment of the present invention, the resin having an amide bond contains a cyclic component. In other words, a specific amount of a part of the resin having an amide bond is a cyclic component which has no terminals. Therefore, in the porous layer in accordance with an embodiment of the present invention, the number of groups at the terminals responsible for oxidative deterioration is smaller than that in the conventional nonaqueous electrolyte secondary battery porous layer. Therefore, the porous layer in accordance with an embodiment of the present invention can inhibit or prevent occurrence of oxidative deterioration and a decrease in initial charge-discharge efficiency of a nonaqueous electrolyte secondary battery caused by the occurrence of oxidative deterioration.

The cyclic component is more soluble in a nonaqueous electrolyte than a chain polymer. Therefore, in a nonaqueous electrolyte secondary battery including the porous layer in accordance with an embodiment of the present invention, at least a part of the cyclic component is eluted into the nonaqueous electrolyte. Note, here, that, in a nonaqueous electrolyte secondary battery, initial charge-discharge efficiency may decrease due to impurities produced when a nonaqueous electrolyte is decomposed during initial charge and discharge. In contrast, in an embodiment of the present invention, the cyclic component seems to exhibit a function of improving structural stability of the nonaqueous electrolyte in the nonaqueous electrolyte. Therefore, it seems that the cyclic component dissolved in the nonaqueous electrolyte inhibits production of the impurities, and as a result, initial charge-discharge efficiency of the nonaqueous electrolyte secondary battery is improved. Therefore, the composition can form a nonaqueous electrolyte secondary battery porous layer which can improve initial charge-discharge efficiency of a nonaqueous electrolyte secondary battery. Moreover, the porous layer can improve initial charge-discharge efficiency of a nonaqueous electrolyte secondary battery including the porous layer.

From the viewpoint of initial charge-discharge efficiency indicated above, in an embodiment of the present invention, the contained amount of the cyclic component is not less than 2.0% by weight, preferably not less than 3.0% by weight, and more preferably not less than 4.0% by weight, with respect to the total weight of the resin having an amide bond.

The porous layer is generally formed by applying a coating solution in which a constituent component has been dissolved to a base material to form a coating layer, and then depositing the constituent component from the coating layer, as described later. Here, the cyclic component is highly soluble in a solvent generally used in the coating solution, and is less likely to be deposited. Therefore, if the porous layer excessively contains the cyclic component, the cyclic component will be excessively contained in the coating solution. As a result, the cyclic component is less likely to be deposited. Therefore, it may be difficult to form a porous layer from the coating layer.

It can be understood that, when compared with the chain polymer, the cyclic component is in an annular form, and therefore a part of a polymer constituting the cyclic component is bent and therefore the cyclic component is smaller. Note, here, that the porous layer is typically formed on a porous base material such as a polyolefin porous film. Therefore, if the porous layer excessively contains the cyclic component, the cyclic component may enter holes in the porous base material, and as a result, the holes may be blocked, and a resistance value of the nonaqueous electrolyte secondary battery may be increased.

From the viewpoint of preventing cases where formation of the porous layer is difficult and the resistance value of the nonaqueous electrolyte secondary battery is increased as described above, in an embodiment of the present invention, the contained amount of the cyclic component is not more than 10.0% by weight, preferably not more than 9.0% by weight, and more preferably not more than 8.0% by weight, with respect to the total weight of the resin having an amide bond.

In an embodiment of the present invention, a contained amount of the resin having an amide bond in the composition or the porous layer is preferably 2.0% by weight to 10.0% by weight, and more preferably 2.0% by weight to 8.0% by weight, with respect to the total weight of the composition or the porous layer.

[Filler]

The composition in accordance with an embodiment of the present invention and the porous layer in accordance with an embodiment of the present invention can each contain a filler.

As to the filler, there are the following types of fillers: organic fillers and inorganic fillers.

Examples of the organic fillers include: homopolymers and copolymers which are each obtained from one or more monomers such as styrene, vinyl ketone, acrylonitrile, methyl methacrylate, ethyl methacrylate, glycidyl methacrylate, glycidyl acrylate, and/or methyl acrylate; fluorine-based resins such as polytetrafluoroethylene, a tetrafluoroethylene-hexafluoropropylene copolymer, a tetrafluoroethylene-ethylene copolymer, and polyvinylidene fluoride; melamine resins; urea resins; polyolefins; and polymethacrylates. Each of these organic fillers may be used alone or two or more of these organic fillers may be alternatively used in combination. Among these organic fillers, a polytetrafluoroethylene powder is preferable in terms of chemical stability.

Examples of the inorganic fillers include materials each made of an inorganic matter such as metal oxide, metal nitride, metal carbide, metal hydroxide, carbonate, or sulfate. Specific examples of the inorganic fillers include: powders of aluminum oxide (such as alumina), boehmite, silica, titania, magnesia, barium titanate, aluminum hydroxide, calcium carbonate, and the like; and minerals such as mica, zeolite, kaolin, and talc. Each of these inorganic fillers may be used alone or two or more of these inorganic fillers may be alternatively used in combination. Among these inorganic fillers, aluminum oxide is preferable in terms of chemical stability.

The shape of each of particles of the filler can be a substantially spherical shape, a plate shape, a columnar shape, a needle shape, a whisker shape, a fibrous shape, or the like. The particles can have any shape. The particles preferably have a substantially spherical shape, because such particles facilitate formation of uniform pores.

The average particle diameter of the filler is preferably 0.01 μm to 1 μm. In this specification, the “average particle diameter of the filler” indicates a volume-based average particle diameter (D50) of the filler. “D50” means a particle diameter having a value at which a cumulative value reaches 50% in a volume-based particle size distribution. D50 can be measured with use of, for example, a laser diffraction particle size analyzer (product names: SALD2200, SALD2300, etc., manufactured by Shimadzu Corporation).

A contained amount of the filler is preferably 20% by weight to 90% by weight, and more preferably 30% by weight to 80% by weight, with respect to the total weight of the composition or the porous layer. In a case where the contained amount of the filler falls within the above range, the resulting porous layer has sufficient ion permeability.

[Other Components]

The composition in accordance with an embodiment of the present invention and the porous layer in accordance with an embodiment of the present invention may each contain a component different from the resin having an amide bond and the filler, as long as such a component does not prevent the object of the present invention from being attained. The other component to be contained may be, for example, a resin different from the resin having an amide bond and an additive which is generally used in a nonaqueous electrolyte secondary battery porous layer. The other component may be one type or may be a mixture of two or more types.

Examples of the resin different from the resin having an amide bond include: polyolefins; (meth)acrylate-based resins; fluorine-containing resins; polyester-based resins; rubbers; resins each having a melting point or a glass transition temperature of not lower than 180° C.; water-soluble polymers; polycarbonates, polyacetals, polyether ether ketones, polybenzimidazoles, polyurethanes, melamine resins, and the like.

Examples of the additive include flame retardants, antioxidants, surfactants, waxes, and the like.

### Embodiment 3: Nonaqueous Electrolyte Secondary Battery Laminated Separator

In the nonaqueous electrolyte secondary battery laminated separator in accordance with Embodiment 3 of the present invention, the porous layer in accordance with Embodiment 2 of the present invention is formed on one surface or both surfaces of the polyolefin porous film. The nonaqueous electrolyte secondary battery laminated separator includes the porous layer in accordance with an embodiment of the present invention. Therefore, the nonaqueous electrolyte secondary battery laminated separator brings about an effect of improving initial charge-discharge efficiency of the nonaqueous electrolyte secondary battery including the nonaqueous electrolyte secondary battery laminated separator.

[Polyolefin Porous Film]

The nonaqueous electrolyte secondary battery laminated separator in accordance with an embodiment of the present invention (hereinafter, simply referred to also as a “laminated separator”) includes a polyolefin porous film. The polyolefin porous film has therein many pores connected to one another. This allows a gas and a liquid to pass through the polyolefin porous film from one side to the other side. The polyolefin porous film can be a base material of the laminated separator. The polyolefin porous film can be one that imparts a shutdown function to the laminated separator by, when a battery generates heat, melting and thereby making the laminated separator non-porous.

Note, here, that a “polyolefin porous film” is a porous film which contains a polyolefin-based resin as a main component. Note that the phrase “contains a polyolefin-based resin as a main component” means that the porous film contains the polyolefin-based resin in a proportion of not less than 50% by volume, preferably not less than 90% by volume, and more preferably not less than 95% by volume, relative to the total amount of materials of which the porous film is made.

The polyolefin-based resin which the polyolefin porous film contains as a main component is not limited to any particular one. Examples of the polyolefin-based resin include homopolymers and copolymers which are each a thermoplastic resin and which are each obtained by polymerizing one or more monomers such as ethylene, propylene, 1-butene, 4-methyl-1-pentene, and/or 1-hexene. Specific examples of the homopolymers include polyethylene, polypropylene, and polybutene. Specific examples of the copolymers include an ethylene-propylene copolymer. The polyolefin porous film can be a layer which contains one type of polyolefin-based resin or can be alternatively a layer which contains two or more types of polyolefin-based resins. Among these polyolefin-based resins, polyethylene is more preferable because polyethylene makes it possible to prevent (shut down) a flow of an excessively large electric current at a lower temperature, and high molecular weight polyethylene which contains ethylene as a main component is particularly preferable. Note that the polyolefin porous film can contain a component other than polyolefin, provided that the component does not impair the function of the polyolefin porous film.

Examples of the polyethylene include low-density polyethylene, high-density polyethylene, linear polyethylene (ethylene-α-olefin copolymer), and ultra-high molecular weight polyethylene. Among these polyethylenes, ultra-high molecular weight polyethylene is more preferable, and ultra-high molecular weight polyethylene which contains a high molecular weight component having a weight-average molecular weight of 5×10⁵ to 15×10⁶ is still more preferable. In particular, the polyolefin-based resin which contains a high molecular weight component having a weight-average molecular weight of not less than 1,000,000 is more preferable, because such a polyolefin-based resin allows the polyolefin porous film and the nonaqueous electrolyte secondary battery laminated separator to each have increased strength.

The polyolefin porous film has a thickness of preferably 5 μm to 20 μm, more preferably 7 μm to 15 μm, and further preferably 9 μm to 15 μm. The polyolefin porous film which has a thickness of not less than 5 μm can sufficiently achieve functions (such as a function of imparting the shutdown function) which the polyolefin porous film is required to have. The polyolefin porous film which has a thickness of not more than 20 μm allows the resulting laminated separator to be thinner.

The pores in the polyolefin porous film each have a diameter of preferably not more than 0.1 μm, and more preferably not more than 0.06 μm. This makes it possible for the nonaqueous electrolyte secondary battery laminated separator to achieve sufficient ion permeability. Furthermore, this makes it possible to more prevent particles, which constitute an electrode, from entering the polyolefin porous film.

The polyolefin porous film typically has a weight per unit area of preferably 4 g/m² to 20 g/m², and more preferably 5 g/m² to 12 g/m², so as to allow a battery to have a higher weight energy density and a higher volume energy density.

The polyolefin porous film has an air permeability of preferably 30 s/100 mL to 500 s/100 mL, and more preferably 50 s/100 mL to 300 s/100 mL, in terms of Gurley values. This allows the laminated separator to achieve sufficient ion permeability.

The polyolefin porous film has a porosity of preferably 20% by volume to 80% by volume, and more preferably 30% by volume to 75% by volume. This makes it possible to (i) increase the amount of an electrolyte retained in the polyolefin porous film and (ii) absolutely prevent (shut down) a flow of an excessively large electric current at a lower temperature.

A method of producing the polyolefin porous film is not limited to a particular method, and any publicly known method can be employed. For example, a method can be employed which involves adding a filler to a thermoplastic resin, forming a resulting mixture into a film, and then removing the filler, as disclosed in Japanese Patent No. 5476844.

Specifically, when, for example, the polyolefin porous film is made of the polyolefin-based resin which contains ultra-high molecular weight polyethylene and low molecular weight polyolefin that has a weight-average molecular weight of not more than 10,000, the polyolefin porous film is preferably produced by, from the viewpoint of production costs, a method including the following steps (1) through (4):

(1) kneading 100 parts by weight of ultra-high molecular weight polyethylene, 5 parts by weight to 200 parts by weight of low molecular weight polyolefin which has a weight-average molecular weight of not more than 10,000, and 100 parts by weight to 400 parts by weight of an inorganic filler such as calcium carbonate to obtain a polyolefin-based resin composition;

(2) forming the polyolefin-based resin composition into a sheet;

(3) removing the inorganic filler from the sheet which has been obtained in the step (2); and

(4) stretching the sheet which has been obtained in the step (3).

Alternatively, the polyolefin porous film may be produced by a method disclosed in any of the above-listed Patent Literatures.

The polyolefin porous film can be alternatively a commercially available product which has the above-described characteristics.

[Physical Properties of Nonaqueous Electrolyte Secondary Battery Laminated Separator]

The laminated separator has an air permeability of preferably not more than 500 s/100 mL, and more preferably not more than 300 s/100 mL, in terms of Gurley values. The porous layer included in the laminated separator has an air permeability of preferably not more than 400 s/100 mL, and more preferably not more than 200 s/100 mL, in terms of Gurley values. When the air permeabilities of the laminated separator and the porous layer fall within the above respective ranges, the laminated separator and the porous layer each have sufficient ion permeability.

The air permeability of the porous layer is calculated by Y−X, where X represents the air permeability of the polyolefin porous film and Y represents the air permeability of the laminated separator. The air permeability of the porous layer can be adjusted by, for example, adjusting the intrinsic viscosity of one or more of the resins and/or the weight per unit area of the porous layer. Generally, as the intrinsic viscosity of a resin decreases, a Gurley value tends to decrease. As the weight per unit area of a porous layer decreases, a Gurley value tends to decrease.

The porous layer included in the laminated separator has a thickness of preferably not more than 10 μm, more preferably not more than 7 μm, and still more preferably not more than 5 μm.

In addition to the polyolefin porous film and the porous layer, the laminated separator may have another layer as necessary. Examples of such a layer include an adhesive layer and a protective layer.

[Method of Producing Nonaqueous Electrolyte Secondary Battery Laminated Separator]

The laminated separator can be produced by forming the porous layer with use of a coating solution obtained by dissolving or dispersing the resin having an amide bond and optionally a filler in a solvent. Examples of a method of forming the coating solution include a mechanical stirring method, an ultrasonic dispersion method, a high-pressure dispersion method, and a media dispersion method. The solvent can be, for example, N-methylpyrrolidone, N,N-dimethylacetamide, N,N-dimethylformamide, or the like.

A method of producing the laminated separator can be, for example, a method which involves preparing the coating solution, applying the coating solution to the polyolefin porous film, and then drying the coating solution so that the porous layer is formed on the polyolefin porous film.

As a method of coating the polyolefin porous film with the coating solution, a publicly known coating method, such as a knife coater method, a blade coater method, a bar coater method, a gravure coater method, or a die coater method, can be employed.

The solvent (dispersion medium) is generally removed by a drying method. Examples of the drying method include natural drying, air-blow drying, heat drying, and drying under reduced pressure. Note, however, that any method can be employed, provided that the solvent (dispersion medium) can be sufficiently removed. Note also that drying can be carried out after the solvent (dispersion medium) contained in the coating material is replaced with another solvent. A method of replacing the solvent (dispersion medium) with another solvent and then removing the another solvent can be specifically as follows: (i) the solvent (dispersion medium) is replaced with a poor solvent having a low boiling point, such as water, alcohol, or acetone, (ii) a solute is deposited, and (iii) drying is carried out.

### Embodiment 4: Nonaqueous Electrolyte Secondary Battery Member, and Embodiment 5: Nonaqueous Electrolyte Secondary Battery

A nonaqueous electrolyte secondary battery member in accordance with Embodiment 4 of the present invention is obtained by including a positive electrode, a nonaqueous electrolyte secondary battery porous layer in accordance with Embodiment 2 of the present invention or a nonaqueous electrolyte secondary battery laminated separator in accordance with Embodiment 3 of the present invention, and a negative electrode, which are disposed in this order. A nonaqueous electrolyte secondary battery in accordance with Embodiment 5 of the present invention includes the nonaqueous electrolyte secondary battery porous layer in accordance with Embodiment 2 of the present invention or the nonaqueous electrolyte secondary battery laminated separator in accordance with Embodiment 3 of the present invention.

Therefore, a nonaqueous electrolyte secondary battery member in accordance with an embodiment of the present invention brings about an effect of improving initial charge-discharge efficiency of a nonaqueous electrolyte secondary battery including the nonaqueous electrolyte secondary battery member. A nonaqueous electrolyte secondary battery in accordance with an embodiment of the present invention brings about an effect of achieving improvement in initial charge-discharge efficiency.

The nonaqueous electrolyte secondary battery in accordance with an embodiment of the present invention typically has a structure in which a negative electrode and a positive electrode face each other with the laminated separator sandwiched therebetween. The nonaqueous electrolyte secondary battery is configured such that a battery element, which includes the structure and an electrolyte with which the structure is impregnated, is enclosed in an exterior member. The nonaqueous electrolyte secondary battery is, for example, a lithium ion secondary battery which achieves an electromotive force through doping with and dedoping of lithium ions.

[Positive Electrode]

Examples of the positive electrode include a positive electrode sheet having a structure in which an active material layer including a positive electrode active material and a binding agent is formed on a current collector. The active material layer may further contain an electrically conductive agent.

Examples of the positive electrode active material include materials each capable of being doped with and dedoped of lithium ions.

Examples of the materials include lithium complex oxides each containing at least one type of transition metal such as V, Ti, Cr, Mn, Fe, Co, Ni, and/or Cu. Examples of the lithium complex oxides include lithium complex oxides each having a layer structure, lithium complex oxides each having a spinel structure, and solid solution lithium-containing transition metal oxides each constituted by a lithium complex oxide having both a layer structure and a spinel structure. Examples of the lithium complex oxides also include lithium cobalt complex oxides and lithium nickel complex oxides. Further, examples of the lithium complex oxides also include lithium complex oxides each obtained by substituting one or more of transition metal atoms, which constitute a large part of any of the above lithium complex oxides, with another or other elements such as Na, K, B, F, Al, Ti, V, Cr, Mn, Fe, Co, Ni, Cu, Zn, Mg, Ca, Ga, Zr, Si, Nb, Mo, Sn, and/or W.

Examples of the lithium complex oxides each obtained by substituting one or more of transition metal atoms, which constitute a large part of any of the above lithium complex oxides, with another or other elements include: lithium cobalt complex oxides each having a layer structure and each represented by Formula (4) below; lithium nickel complex oxides each represented by Formula (5) below; lithium-manganese complex oxides each having a spinel structure and each represented by Formula (6) below; and solid solution lithium-containing transition metal oxides each represented by Formula (7) below.

Li[Liₓ(Co₁₋ₐM¹ₐ)₁₋ₓ]O₂ Formula (4):

where: M¹ is at least one type of metal selected from the group consisting of Na, K, B, F, Al, Ti, V, Cr, Mn, Fe, Ni, Cu, Zn, Mg, Ga, Zr, Si, Nb, Mo, Sn, and W; and −0.1≤x≤0.30 and 0≤a≤0.5 are satisfied.

Li[Li_{y}(Ni_{1-b}M²_{b})_{1-y}]O₂ Formula (5):

where: M² is at least one type of metal selected from the group consisting of Na, K, B, F, Al, Ti, V, Cr, Mn, Fe, Co, Cu, Zn, Mg, Ga, Zr, Si, Nb, Mo, Sn, and W; and −0.1≤y≤0.30 and 0≤b≤0.5 are satisfied.

Li_{z}Mn_{2-c}M³_{c}O₄ Formula (6):

where: M³ is at least one type of metal selected from the group consisting of Na, K, B, F, Al, Ti, V, Cr, Fe, Co, Ni, Cu, Zn, Mg, Ga, Zr, Si, Nb, Mo, Sn, and W; and 0.9≤z and 0≤c≤1.5 are satisfied.

Li_{1+w}M⁴_{d}M⁵ₑO₂ Formula (7):

where: M⁴ and M⁵ are each independently at least one type of metal selected from the group consisting of Al, Ti, V, Cr, Mn, Fe, Co, Ni, Cu, Zn, Mg, and Ca; and 0<w≤1/3, 0≤d≤2/3, 0≤e≤2/3, and w+d+e=1 are satisfied.

Specific examples of the lithium complex oxides represented by Formulae (4) to (7) include LiCoO₂, LiNiO₂, LiMnO₂, LiNi_{0.8}Co_{0.2}O₂, LiNi_{0.5}Mn_{0.5}O₂, LiNi_{0.85}Co_{0.10}Al_{0.05}O₂, LiNi_{0.8}Co_{0.15}Al_{0.05}O₂, LiNi_{0.5}Co_{0.2}Mn_{0.3}O₂, LiNi_{0.6}Co_{0.2}Mn_{0.2}O₂, LiNi_{0.33}Co_{0.33}Mn_{0.33}O₂, LiMn₂O₄, LiMn_{1.5}Ni_{0.5}O₄, LiMn_{1.5}Fe_{0.5}O₄, LiCoMnO₄, Li_{1.21}Ni_{0.20}Mn_{0.59}O₂, Li_{1.22}Ni_{0.20}Mn_{0.58}O₂, Li_{1.22}Ni_{0.15}Co_{0.10}Mn_{0.53}O₂, Li_{1.07}Ni_{0.35}Co_{0.08}Mn_{0.50}O₂, and Li_{1.07}Ni_{0.36}Co_{0.08}Mn_{0.49}O₂.

Lithium complex oxides other than the lithium complex oxides represented by Formulae (4) to (7) can be also preferably used as the positive electrode active material. Examples of such lithium complex oxides include LiNiVO₄, LiV₃O₆, and Li_{1.2}Fe_{0.4}Mn_{0.4}O₂.

Examples of a material which can be preferably used as the positive electrode active material, other than the lithium complex oxides, include phosphates each having an olivine-type structure. Specific examples of such phosphates include phosphates each having an olivine-type structure and each represented by the following Formula (8).

Liᵥ(M⁶_{f}M⁷_{g}M⁸ₕM⁹ᵢ)ⱼPO₄ Formula (8):

where: M⁶ is Mn, Co, or Ni; M⁷ is Ti, V, Cr, Mn, Fe, Co, Ni, Zr, Nb, or Mo; M⁸ is a transition metal, optionally excluding the elements in the groups VIA and VIIA, or a representative element; M⁹ is a transition metal, optionally excluding the elements in the groups VIA and VIIA, or a representative element; and 1.2≥a≥0.9, 1≥b≥0.6, 0.4≥c≥0, 0.2≥d≥0, 0.2≥e≥0, and 1.2≥f≥0.9 are satisfied.

In the positive electrode active material, each of surfaces of lithium metal complex oxide particles constituting the positive electrode active material is preferably coated with a coating layer. Examples of a material of which the coating layer is made include metal complex oxides, metal salts, boron-containing compounds, nitrogen-containing compounds, silicon-containing compounds, and sulfur-containing compounds. Among these materials, metal complex oxides are suitably used.

The metal complex oxides are preferably oxides each having lithium ion conductivity. Examples of such metal complex oxides include metal complex oxides of Li and at least one type of element selected from the group consisting of Nb, Ge, Si, P, Al, W, Ta, Ti, S, Zr, Zn, V, and B. When the positive electrode active material is a material particles of which each have a coating layer, the coating layer suppresses a side reaction which occurs at the interface between the positive electrode active material and the electrolyte substance at high voltages, and the resulting secondary battery can achieve a longer life. Moreover, the coating layer suppresses formation of a high-resistance layer at the interface between the positive electrode active material and the electrolyte substance, and the resulting secondary battery can achieve high output.

Examples of the electrically conductive agent include carbonaceous materials such as natural graphite, artificial graphite, cokes, carbon black, pyrolytic carbons, carbon fibers, and fired products of organic polymer compounds.

Examples of the binding agent include: thermoplastic resins such as polyvinylidene fluoride, a vinylidene fluoride copolymer, polytetrafluoroethylene, a vinylidene fluoride-hexafluoropropylene copolymer, a tetrafluoroethylene-hexafluoropropylene copolymer, a tetrafluoroethylene-perfluoroalkyl vinyl ether copolymer, an ethylene-tetrafluoroethylene copolymer, a vinylidene fluoride-tetrafluoroethylene copolymer, a vinylidene fluoride-trifluoroethylene copolymer, a vinylidene fluoride-trichloroethylene copolymer, a vinylidene fluoride-vinyl fluoride copolymer, a vinylidene fluoride-hexafluoropropylene-tetrafluoroethylene copolymer, thermoplastic polyimide, polyethylene, and polypropylene; acrylic resins; and styrene-butadiene rubber. Note that the binding agent serves also as a thickener.

Examples of the positive electrode current collector include electric conductors such as Al, Ni, and stainless steel. Among these electric conductors, Al is more preferable because Al is easily processed into a thin film and is inexpensive.

Examples of a method of producing the positive electrode sheet include: a method which involves pressure-molding, on the positive electrode current collector, the positive electrode active material, the electrically conductive agent, and the binding agent which constitute a positive electrode mix; and a method which involves (i) forming, into a paste, the positive electrode active material, the electrically conductive agent, and the binding agent with use of an appropriate organic solvent to obtain the positive electrode mix, (ii) coating the positive electrode current collector with the positive electrode mix, (iii) drying the positive electrode mix, and then (iv) pressuring the resulting sheet-shaped positive electrode mix on the positive electrode current collector so that the sheet-shaped positive electrode mix is firmly fixed to the positive electrode current collector.

[Negative Electrode]

The negative electrode can be, for example, a negative electrode sheet having a structure in which an active material layer, containing a negative electrode active material and a binding agent, is formed on a current collector. The active material layer may further contain an electrically conductive agent.

Examples of the negative electrode active material include carbon materials, chalcogen compounds (such as oxides and sulfides), nitrides, metals, and alloys each of which is capable of being doped with and dedoped of lithium ions at electric potentials lower than that of the positive electrode.

Examples of the carbon materials which can be used as the negative electrode active material include graphites such as natural graphite and artificial graphite, cokes, carbon black, pyrolytic carbons, carbon fibers, and fired products of organic polymer compounds.

Examples of the oxides which can be used as the negative electrode active material include: oxides of silicon which are represented by a formula SiOₓ (where x is a positive real number), such as SiO₂ and SiO; oxides of titanium which are represented by a formula TiOₓ (where x is a positive real number), such as TiO₂ and TiO; oxides of vanadium which are represented by a formula VₓO_{y} (where x and y are each a positive real number), such as V₂O₅ and VO₂; oxides of iron which are represented by a formula FeₓO_{y} (where x and y are each a positive real number), such as Fe₃O₄, Fe₂O₃, and FeO; oxides of tin which are represented by a formula SnOₓ (where x is a positive real number) such as SnO₂ and SnO; oxides of tungsten which are represented by a general formula WOₓ (where x is a positive real number) such as WO₃ and WO₂; and complex metal oxides each of which contains lithium and titanium or vanadium, such as Li₄Ti₅O₁₂ and LiVO₂.

Examples of the sulfides which can be used as the negative electrode active material include: sulfides of titanium which are represented by a formula TiₓS_{y} (where x and y are each a positive real number), such as Ti₂S₃, TiS₂, and TiS; sulfides of vanadium which are represented by a formula VSx (where x is a positive real number), such as V₃S₄, VS₂, and VS; sulfides of iron which are represented by a formula FeₓS_{y} (where x and y are each a positive real number), such as Fe₃S₄, FeS₂, and FeS; sulfides of molybdenum which are represented by a formula MoₓS_{y} (where x and y are each a positive real number), such as Mo₂S₃ and MoS₂; sulfides of tin which are represented by a formula SnSₓ (where x is a positive real number) such as SnS₂ and SnS; sulfides of tungsten which are represented by a formula WSₓ (where x is a positive real number), such as WS₂; sulfides of antimony which are represented by a formula SbₓS_{y} (where x and y are each a positive real number), such as Sb₂S₃; and sulfides of selenium which are represented by a formula SeₓS_{y} (where x and y are each a positive real number), such as Se₅S₃, SeS₂, and SeS.

Examples of the nitrides which can be used as the negative electrode active material include lithium-containing nitrides such as Li₃N and Li₃₋ₓAₓN (where A is one or both of Ni and Co, and 0<x<3 is satisfied).

Each of these carbon materials, oxides, sulfides, and nitrides may be used alone or two or more of these carbon materials, oxides, sulfides, and nitrides may be used in combination. These carbon materials, oxides, sulfides, and nitrides can be each crystalline or amorphous. One or more of these carbon materials, oxides, sulfides, and nitrides are mainly supported by the negative electrode current collector, and the resulting negative electrode current collector is used as an electrode.

Examples of the metals which can be used as the negative electrode active material include lithium metals, silicon metals, and tin metals.

It is also possible to use a complex material which contains Si or Sn as a first constituent element and also contains second and/or third constituent elements. The second constituent element is, for example, at least one type of element selected from cobalt, iron, magnesium, titanium, vanadium, chromium, manganese, nickel, copper, zinc, gallium, and zirconium. The third constituent element is, for example, at least one type of element selected from boron, carbon, aluminum, and phosphorus.

In particular, since a high battery capacity and excellent battery characteristics are achieved, the above metal material is preferably a simple substance of silicon or tin (which may contain a slight amount of impurities), SiOᵥ (0<v≤2), SnO_{w} (0 w 2), an Si—Co—C complex material, an Si—Ni—C complex material, an Sn—Co—C complex material, or an Sn—Ni—C complex material.

Examples of the negative electrode current collector include Cu, Ni, and stainless steel. Among these materials, Cu is more preferable because Cu is not easily alloyed with lithium particularly in a lithium-ion secondary battery and is easily processed into a thin film.

Examples of a method of producing the negative electrode sheet include: a method which involves pressure-molding, on the negative electrode current collector, the negative electrode active material which constitutes a negative electrode mix; and a method which involves (i) forming the negative electrode active material into a paste with use of an appropriate organic solvent to obtain the negative electrode mix, (ii) coating the negative electrode current collector with the negative electrode mix, (iii) drying the negative electrode mix, and then (iv) pressing the resulting sheet-shaped negative electrode mix on the negative electrode current collector so that the sheet-shaped negative electrode mix is firmly fixed to the negative electrode current collector. The paste preferably contains an electrically conductive agent as described above and a binding agent as described above.

[Nonaqueous Electrolyte]

The nonaqueous electrolyte can be, for example, a nonaqueous electrolyte obtained by dissolving a lithium salt in an organic solvent. Examples of the lithium salt include LiClO₄, LiPF₆, LiAsF₆, LiSbF₆, LiBF₄, LiSO₃F, LiCF₃SO₃, LiN(SO₂CF₃)₂, LiN(SO₂C₂F₅)₂, LiN(SO₂CF₃)(COCF₃), Li(C₄FgSO₃), LiC(SO₂CF₃)₃, Li₂B₁₀Cl₁₀, LiBOB (BOB refers to bis(oxalato)borate), lower aliphatic carboxylic acid lithium salt, and LiAlCl₄. Each of these lithium salts may be used alone or two or more of these lithium salts may be used as a mixture. Among these lithium salts, it is preferable to use at least one fluorine-containing lithium salt selected from the group consisting of LiPF₆, LiAsF₆, LiSbF₆, LiBF₄, LiSO₃F, LiCF₃SO₃, LiN(SO₂CF₃)₂, and LiC(SO₂CF₃)₃.

Examples of the organic solvent include carbonates such as propylene carbonate, ethylene carbonate, dimethyl carbonate, diethyl carbonate, ethyl methyl carbonate, 4-trifluoromethyl-1,3-dioxolane-2-on, and 1,2-di(methoxy carbonyloxy)ethane; ethers such as 1,2-dimethoxyethane, 1,3-dimethoxypropane, pentafluoropropyl methylether, 2,2,3,3-tetrafluoropropyl difluoro methylether, tetrahydrofuran, and 2-methyl tetrahydrofuran; esters such as methyl formate, methyl acetate, and γ-butyrolactone; nitriles such as acetonitrile and butyronitrile; amides such as N,N-dimethylformamide and N,N-dimethylacetamide; carbamates such as 3-methyl-2-oxazolidone; sulfur-containing compounds such as sulfolane, dimethyl sulfoxide, and 1,3-propane sultone; and compounds each prepared by introducing a fluoro group into any of these organic solvents (i.e., compounds each prepared by substituting one or more hydrogen atoms of any of these organic solvents with one or more respective fluorine atoms).

The organic solvent is preferably a mixed solvent obtained by mixing two or more of the above organic solvents. Particularly, the organic solvent is preferably a mixed solvent containing a carbonate, further preferably a mixed solvent containing a cyclic carbonate and an acyclic carbonate or a mixed solvent containing a cyclic carbonate and an ether. The mixed solvent containing a cyclic carbonate and an acyclic carbonate is preferably a mixed solvent containing ethylene carbonate, dimethyl carbonate, and ethyl methyl carbonate. The nonaqueous electrolyte which contains such a mixed solvent has advantages of having a wider operating temperature range, being less prone to deterioration even when used at a high voltage, being less prone to deterioration even when used for a long period of time, and less prone to decomposition even when the negative electrode active material is a graphite material such as natural graphite or artificial graphite.

It is preferable to use, as the nonaqueous electrolyte, a nonaqueous electrolyte containing (i) a lithium salt containing fluorine (such as LiPF₆) and (ii) an organic solvent containing a fluorine substituent, because such a nonaqueous electrolyte allows the resulting nonaqueous electrolyte secondary battery to have increased safety. It is further preferable to use a mixed solvent containing a dimethyl carbonate and an ether having a fluorine substituent (such as pentafluoropropyl methylether or 2,2,3,3-tetrafluoropropyl difluoro methylether), because such a mixed solvent allows the resulting nonaqueous electrolyte secondary battery to have a high capacity maintenance ratio even when the nonaqueous electrolyte secondary battery is discharged at a high voltage.

[Method of Producing Nonaqueous Electrolyte Secondary Battery Member and Method of Producing Nonaqueous Electrolyte Secondary Battery]

A method of producing the nonaqueous electrolyte secondary battery member can be, for example, a method which involves disposing the positive electrode, the nonaqueous electrolyte secondary battery laminated separator in accordance with an embodiment of the present invention, and the negative electrode in this order.

A method of producing the nonaqueous electrolyte secondary battery can be, for example, the following method. First, the nonaqueous electrolyte secondary battery member is placed in a container which is to be a housing of the nonaqueous electrolyte secondary battery. Next, the container is filled with the nonaqueous electrolyte, and then the container is hermetically sealed while pressure inside the container is reduced. In this manner, it is possible to produce the nonaqueous electrolyte secondary battery.

The present invention is not limited to the embodiments, but can be altered variously by a skilled person in the art within the scope of the claims. The present invention also encompasses, in its technical scope, any embodiment derived by appropriately combining technical means disclosed in differing embodiments.

### EXAMPLES

The following description will discuss embodiments of the present invention in more detail with reference to Examples and Comparative Example. Note, however, that the present invention is not limited to such Examples and Comparative Example.

[Methods of Measuring Various Physical Property Values]

Physical property values of a composition, a porous layer, a laminated separator, and a nonaqueous electrolyte secondary battery which were prepared in Examples and Comparative Example described later were measured by methods below.

[Thickness]

Thicknesses of the laminated separator and the porous film were measured with the use of a high-precision digital measuring device (VL-50) manufactured by Mitutoyo Corporation. Further, a difference between the thickness of the laminated separator and the thickness of the porous film was calculated, and the difference was regarded as a thickness of the porous layer.

[Weight Per Unit Area]

In advance, a sample in the form of an 8 cm square was cut out from each of porous films which had been used in Examples and Comparative Example described later, and a weight W(g) of the sample was measured. Then, a weight per unit area of the porous film was calculated according to the following Formula (9).

Weight per unit area of porous film (g/m²)=W/(0.08×0.08) Formula (9):

Similarly, a sample in the form of an 8 cm square was cut out from the laminated separator, and a weight W(g) of the sample was measured. Then, a weight per unit area of the laminated separator was calculated according to the following Formula (10).

Weight per unit area (g/m²) of laminated separator=W/(0.08×0.08) Formula (10):

A weight per unit area of the porous layer was calculated according to the following Formula (11) with use of the weight per unit area of the laminated separator and the weight per unit area of the porous film.

Weight per unit area (g/m²) of porous layer=(weight per unit area of laminated separator)−(weight per unit area of porous film) Formula (11):

[Air Permeability]

The air permeability (Gurley value) of the laminated separator was measured in conformity to JIS P8117.

[Intrinsic Viscosity]

The intrinsic viscosity was measured by the following measurement method. A solution was prepared by dissolving 0.5 g of wholly aromatic polyamide in 100 mL of 96% to 98% sulfuric acid. Subsequently, with use of a capillary viscometer, a period of time which the solution took to flow through the capillary viscometer at 30° C. and a period of time which 96% to 98% sulfuric acid took to flow through the capillary viscometer at 30° C. were measured, and an intrinsic viscosity was calculated by the following formula with use of a ratio of the measured periods of time.

Intrinsic viscosity=ln(T/T₀)/C (unit: dL/g)

In the above formula, T and T₀ respectively represent the periods of time taken by the sulfuric acid solution of the wholly aromatic polyamide and the sulfuric acid to flow through the capillary viscometer, and C represents a concentration (g/dL) of the wholly aromatic polyamide in the sulfuric acid solution of the wholly aromatic polyamide.

[Contained Amount of Cyclic Component]

From each of the compositions which were obtained in Examples and Comparative Example described later and contained a cyclic component and a chain polymer, 970 mg of the composition was weighed and collected. The collected composition (970 mg) was added to 9 mL of a mixed solvent which was obtained by mixing tetrahydrofuran (THF) and N-methylpyrrolidone (NMP) in a volume ratio of 8:2, and a suspension of the composition was obtained. The suspension was left to stand still for 17 hours, then stirred with a touch mixer for 1 minute, and filtration was carried out with a PTFE membrane filter having a pore diameter of 0.45 μm. The resulting filtrate was subjected to matrix-assisted laser desorption ionization mass spectrometry (MALDI-MS), and m/z=1535.3, 1913.3, 2291.4, 2669.5, 3047.5, and the like were obtained as monoisotopic ions. Measurement was carried out in a spiral TOF mode of positive ions of JMS-S3000 SpiralTOF manufactured by JEOL LTD., with trans-2-7[3-(4-tert-butylphenyl)-2-methyl-2-propenylidene]malononitrile (DCTB) as a matrix and sodium trifluoroacetate (NaTFA) as a cationizing agent. It was confirmed that sodium had been added to the resulting ions, and that the extract contained in the filtrate was a cyclic component. Subsequently, 30 mg of the composition was weighed and collected. The collected composition (30 mg) was added to 15 mL of a mixed solvent obtained by mixing THF and NMP in a volume ratio of 8:2, stirred for 1 minute with use of a touch mixer, and was then left to stand still for 17 hours. Thus, the cyclic component was dissolved in the mixed solvent to obtain a THF/NMP solution. Similarly, 30 mg of the composition was weighed and collected, and added to 15 mL of NMP. The mixture was left to stand still for 17 hours, and the composition was entirely dissolved to obtain an NMP solution which contained a cyclic component and a chain polymer. After that, the THF/NMP solution and the NMP solution were each filtered with a PTFE membrane filter having a pore diameter of 0.45 μm to obtain a filtrate. For each of the obtained filtrates, a size exclusion chromatography (SEC) measurement was carried out under the following conditions. A device used was equivalent to LC-20A manufactured by Shimadzu Corporation. A column was made by connecting two TSK-GEL SUPER AWM-H manufactured by Tosoh Corporation. NMP in which 30 mM of LiBr was dissolved was used as an eluting solution. A flow rate was 0.4 mL/min. A column temperature was 40° C. Detection was carried out with UV having a wavelength of 310 nm. The contained amount of the cyclic component was calculated according to Formula (12) below from chromatograms obtained from the respective filtrates. In Formula (12), an area value in the chromatogram obtained with the THF/NMP solution is referred to as “area value in THF/NMP solution”, and an area value in the chromatogram obtained with the NMP solution is referred to as “area value in NMP solution”.

Contained amount of cyclic component (% by weight)=area value in THF/NMP solution/area value in NMP solution Formula (12):

Note that, in Examples and Comparative Example described later, first, a composition which was prepared as a raw material of a porous layer was used as a composition containing the cyclic component and the chain polymer, and the contained amount of the cyclic component in the composition was measured by the method described above. Subsequently, a laminated separator including the porous layer and a nonaqueous electrolyte secondary battery including the laminated separator were produced by a method described later, and initial charge-discharge efficiency was measured. After that, a composition which was constituted by a block copolymer obtained by the method described below from the nonaqueous electrolyte secondary battery was used as a composition containing the cyclic component and the chain polymer, and the contained amount of the cyclic component in the porous layer was measured by the above described method.

From the nonaqueous electrolyte secondary battery after measurement of initial charge-discharge efficiency, the laminated separator was taken out, and the porous layer included in the laminated separator was washed with diethyl carbonate. Thus, a solution containing a block copolymer which was a component constituting the porous layer and aluminum oxide which was a filler was obtained. By filtrating the solution obtained by the washing, the aluminum oxide was removed, and a liquid in which the block copolymer, i.e., the cyclic component and the chain polymer were dissolved or dispersed in diethyl carbonate was obtained. The liquid was weighed and collected by 1 L. To the collected liquid (1 L), 1 L of ion-exchange water was added, and a deposition operation was carried out in which the block copolymer which had been dissolved was deposited. From the liquid after the deposition operation, the block copolymer was separated by a filtration operation to obtain a composition constituted by the block copolymer. Note that, in the filtration operation, the liquid after the deposition operation was filtered once, and then the filtrate obtained by the filtration was filtered again, i.e., filtration was carried out twice.

[Initial Charge-Discharge Efficiency]

<Preparation of Nonaqueous Electrolyte Secondary Battery for Test>

A nonaqueous electrolyte secondary battery for a test was produced by a method shown in the following steps 1 through 4 with use of nonaqueous electrolyte secondary battery laminated separators obtained in Examples and Comparative Example described later.

1. A positive electrode and a negative electrode were prepared. The positive electrode was an electrode hoop which had been purchased from JFE Techno-Research Corporation and which had a thickness of 51 μm and a density of 2.95 g/cm³. The composition of a positive electrode active material was such that the amount of LiNi_{0.8}Co_{0.15}Al_{0.05}O₂ was 92 parts by weight, the amount of an electrically conductive agent was 4 parts by weight, and the amount of a binding agent was 4 parts by weight. The negative electrode was an electrode hoop which had been purchased from JFE Techno-Research Corporation and which had a thickness of 59 μm and a density of 1.45 g/cm³. The composition of a negative electrode active material was such that the amount of artificial graphite was 96.5 parts by weight, the amount of a binding agent was 2 parts by weight, and the amount of carboxymethyl cellulose was 1.5 parts by weight.
2. A nonaqueous electrolyte secondary battery member was produced. The positive electrode, the laminated separator, and the negative electrode were disposed in this order in a laminate pouch. In so doing, the laminated separator was disposed such that (i) the porous layer of the laminated separator and a positive electrode active material layer of the positive electrode were in contact with each other and (ii) a polyethylene porous film of the laminated separator and a negative electrode active material layer of the negative electrode were in contact with each other.
3. The nonaqueous electrolyte secondary battery member was stored in a bag which was made up of an aluminum layer and a heat-sealing layer that was formed on the aluminum layer, and 230 μL of a nonaqueous electrolyte was injected into the bag. The nonaqueous electrolyte was one that had been prepared by dissolving LiPF₆ at a concentration of 1 mol/L in a mixed solvent obtained by mixing ethylene carbonate, ethyl methyl carbonate, and diethyl carbonate at a ratio of 3:5:2 (volume ratio).
4. The bag was heat-sealed while pressure inside the bag was reduced. A nonaqueous electrolyte secondary battery for a test was thus produced.

<Measurement of Initial Charge-Discharge Efficiency>

A nonaqueous electrolyte secondary battery for a test which was prepared by the above described method was subjected to one cycle of initial charge and discharge at a room temperature of 25° C. under conditions of a CC charge in which an ending voltage was 4.2 V and a charge current value was 0.1 C, and a CC discharge in which an ending voltage was 2.7 V and a discharge current value was 0.2 C, using a charge-discharge tester manufactured by TOYO SYSTEM CO., LTD (where a value of an electric current at which a battery rated capacity defined as a one-hour rate discharge capacity was discharged in one hour was assumed to be 1 C). At that time, a charge capacity (mAh) and a discharge capacity (mAh) were measured in the initial charge and discharge. Initial charge-discharge efficiency (%) was calculated according to the following Formula (13) with use of the charge capacity and the discharge capacity at the initial charge and discharge.

Initial charge-discharge efficiency (%)={discharge capacity (mAh) at initial charge and discharge/charge capacity (mAh) at initial charge and discharge}×100 Formula (13):

### Example 1

<Preparation of Composition>

A composition was prepared by a method which included the following steps (a) through (g).

(a) A 5-L separable flask having a stirring blade, a thermometer, a nitrogen incurrent canal, and a powder addition port was sufficiently dried.

(b) 4217 g of NMP was introduced into the flask. Further, 324.22 g of calcium chloride (which had been dried at 200° C. for 2 hours) was added, and a resulting mixture was heated to 100° C. The calcium chloride was completely dissolved to obtain a solution of calcium chloride. Here, in the solution of calcium chloride, a concentration of calcium chloride was 7.14% by weight, and a water content was adjusted to be 500 ppm.

(c) To the solution of calcium chloride, 151.559 g of 4,4′-diaminodiphenylsulfone (DDS) was added while the temperature was maintained at 100° C., and the DDS was completely dissolved to obtain a solution A(1).

(d) The resulting solution A(1) was cooled to 25° C. After that, to the solution A which had been cooled, a total of 123.304 g of terephthalic acid dichloride (TPC) was added in three separate portions while the temperature was maintained at 25±2° C. A reaction was then caused to occur for 1 hour, and a reaction solution A(1) was obtained. In the reaction solution A(1), poly(4,4′-diphenylsulfonyl terephthalamide) was prepared. The prepared poly(4,4′-diphenylsulfonyl terephthalamide) is composed of a chain polymer and a cyclic component. That is, in the reaction solution A(1), a block A(1) which was constituted by the poly(4,4′-diphenylsulfonyl terephthalamide) in the form of a chain polymer and a cyclic component (1) which was constituted by the poly(4,4′-diphenylsulfonyl terephthalamide) in the form of a cyclic component were prepared.

(e) From the reaction solution A(1) obtained, 50 mL of the solution used for measuring the cyclic component described later was weighed and collected. To the remaining reaction solution A(1), 66.003 g of paraphenylenediamine (PPD) was added, and completely dissolved over 1 hour to obtain a solution B(1).

(f) To the solution B(1), a total of 123.049 g of TPC was added in three separate portions while the temperature was maintained at 25±2° C. A reaction was then caused to occur for 1.5 hours, and a reaction solution B(1) was obtained. In the reaction solution B(1), blocks B(1), each of which was constituted by poly(paraphenylene terephthalamide), extended on both sides of the block A(1).

(g) While the temperature of the reaction solution B(1) was maintained at 25±2° C., the solution was matured for 1 hour. After that, the solution was stirred for 1 hour under reduced pressure, and air bubbles were removed. As a result, a solution was obtained which contained a block copolymer (1) in which the block A(1) accounted for 50% of the entirety of a molecule and the block B(1) accounted for the remaining 50% of the entirety of the molecule. The block copolymer (1) is a chain polymer. It can be said that the solution containing the block copolymer (1) contains, as a resin (1) having an amide bond, a resin which is constituted by the block copolymer (1) and the cyclic component (1).

Note that, in Example 1, the proportion of the total weight of the block A(1) and the cyclic component (1) relative to the weight of the reaction solution A(1) was 4.82% by weight.

In another flask different from the separable flask, 0.5 L of ion-exchange water was introduced. Further, the solution containing the block A(1) and the cyclic component (1), i.e., the reaction solution A(1) was weighed and collected by 50 mL. After that, the collected reaction solution A(1) (50 mL) was added to said another flask, and the block A(1) and the cyclic component (1) were deposited. The deposited block A(1) and cyclic component (1) were separated by a filtration operation to obtain 2.4 g of a composition (1) which was constituted by the block A(1) and the cyclic component (1). Note that, in the filtration operation, the solution remained after the deposition of the block A(1) and the cyclic component (1) was filtered once, and then 100 mL of ion-exchange water was added to the resulting deposit containing the block A(1) and the cyclic component (1) and filtration was carried out again. That is, filtration was carried out twice.

The obtained composition (1) was weighed and collected by 60 mg, and with use of the collected composition (1) (60 mg), a contained amount of a cyclic component in the composition (1) was measured by the above described method. Note that blocks B(1) extend on both sides of the chain component in the block A(1) to produce a chain polymer in the block copolymer (1). Meanwhile, the cyclic component (1) does not react with the blocks B(1). Therefore, the cyclic component (1) is a cyclic component in the resin (1) having an amide bond. Therefore, the contained amount of the cyclic component (1) in the composition (1) is identical with that of the cyclic component in the resin (1) having an amide bond.

<Preparation of Porous Layer and Laminated Separator>

The resulting resin (1) having an amide bond was used to produce a porous layer and a laminated separator by the following method.

To 4000 g of the solution containing the resin (1) having an amide bond, 8.56 L of NMP was added, and a solution in which the resin (1) having an amide bond was dissolved and dispersed was obtained. To the solution in which the resin (1) having an amide bond was dissolved and dispersed, 300.0 g of aluminum oxide (average particle diameter: 0.013 μm) was added. A resulting mixture was uniformly dispersed with use of a pressure type disperser to prepare a coating solution. A solid content concentration of the coating solution was 5.0% by weight.

The coating solution was applied to a polyethylene porous film (thickness: 10 μm, weight per unit area: 5.6 g/m²), and the polyethylene porous film to which the coating solution was applied was treated in an oven at 50° C. and a humidity of 70% for 2 minutes so that a porous layer was formed. After that, the resulting polyethylene porous film and porous layer were washed with water and dried to obtain a laminated separator including the porous layer.

Physical property values of the porous layer and the laminated separator were measured by the above described methods. Further, with use of the laminated separator, measurement of initial charge-discharge efficiency and measurement of a contained amount of the cyclic component in the porous layer were carried out by the above described methods.

### Example 2

A reaction solution A(2) and a resin (2) that contained a block copolymer (2) in which the block A(2) accounted for 50% of the entirety of a molecule and the block B(2) accounted for the remaining 50% of the entirety of the molecule, that contained a cyclic component (2), and that had an amide bond were obtained in a manner similar to that in Example 1, except that the amount of DDS used in the step (c) was changed to 140.659 g, the total amount of TPC used in each of the steps (d) and (f) was changed to 227.942 g, and the amount of PPD used in the step (f) was changed to 61.259 g. Note that, in Example 2, the weight of the block A(2) relative to the weight of the reaction solution A(2) was 4.48% by weight. In a manner similar to that in Example 1, 2.24 g of a composition (2) which was constituted by the block A(2) and the cyclic component (2) was obtained.

A contained amount of the cyclic component in the composition was measured in a manner similar to that in Example 1, except that the composition (2) was used instead of the composition (1). A porous layer and a laminated separator were prepared, physical property values of the porous layer and the laminated separator were measured, initial charge-discharge efficiency was measured, and a contained amount of a cyclic component in the porous layer was measured in a manner similar to that in Example 1, except that a solution containing the resin (2) having an amide bond was used instead of the solution containing the resin (1) having an amide bond, and that the amount of NMP used was changed to 6.83 L and the amount of aluminum oxide used was changed to 280.0 g.

### Example 3

A reaction solution A(3) and a resin (3) that contained a block copolymer (3) in which the block A(3) accounted for 50% of the entirety of a molecule and the block B(3) accounted for the remaining 50% of the entirety of the molecule, that contained a cyclic component (3), and that had an amide bond were obtained in a manner similar to that in Example 1, except that the amount of NMP used in the step (a) was changed to 4177 g, the amount of calcium chloride used was changed to 366.29 g, the amount of DDS used in the step (c) was changed to 141.119 g, the total amount of TPC used in each of the steps (d) and (f) was changed to 226.911 g, the amount of PPD used in the step (f) was changed to 61.460 g, the concentration of calcium chloride in the solution of calcium chloride used was set to 8.0% by weight, and the water content in the solution of calcium chloride was adjusted to be 300 ppm. Note that, in Example 3, the weight of the block A(3) relative to the weight of the reaction solution A(3) was 4.48% by weight. In a manner similar to that in Example 1, 2.24 g of a composition (3) which was constituted by the block A(3) and the cyclic component (3) was obtained.

A contained amount of the cyclic component in the composition was measured in a manner similar to that in Example 1, except that the composition (3) was used instead of the composition (1). A porous layer and a laminated separator were prepared, physical property values of the porous layer and the laminated separator were measured, initial charge-discharge efficiency was measured, and a contained amount of a cyclic component in the porous layer was measured in a manner similar to that in Example 1, except that a solution containing the resin (3) having an amide bond was used instead of the solution containing the resin (1) having an amide bond, and that the amount of NMP used was changed to 6.83 L and the amount of aluminum oxide used was changed to 280.0 g.

### Example 4

A reaction solution A(4) and a resin (4) that contained a block copolymer (4) in which the block A(4) accounted for 50% of the entirety of a molecule and the block B(4) accounted for the remaining 50% of the entirety of the molecule, that contained a cyclic component (4), and that had an amide bond were obtained in a manner similar to that in Example 1, except that the amount of NMP used in the step (a) was changed to 4177 g, the amount of calcium chloride used was changed to 366.29 g, the amount of DDS used in the step (c) was changed to 141.119 g, the total amount of TPC used in each of the steps (d) and (f) was changed to 226.911 g, the amount of PPD used in the step (f) was changed to 61.460 g, the concentration of calcium chloride in the solution of calcium chloride used was set to 8.0% by weight, and the water content in the solution of calcium chloride was adjusted to be 300 ppm. Note that, in Example 4, the weight of the block A(4) relative to the weight of the reaction solution A(4) was 4.48% by weight. In a manner similar to that in Example 1, 2.24 g of a composition (4) which was constituted by the block A(4) and the cyclic component (4) was obtained.

(h) 4590 g of NMP whose water content was adjusted to 300 ppm was introduced into a sufficiently dried separable flask having a stirring blade, a thermometer, a nitrogen incurrent canal, and a powder addition port.

To the solution of NMP, 15.114 g of DDS was added while the temperature was maintained at 100° C., and the DDS was completely dissolved to obtain a solution C(4). The resulting solution C(4) was cooled to 25° C. After that, to the solution C(4) which had been cooled, 12.235 g of TPC was added while the temperature was maintained at 25±2° C. A reaction was then caused to occur for 1 hour, and a reaction solution C(4) was obtained. In the reaction solution C(4), poly(4,4′-diphenylsulfonyl terephthalamide) was prepared. The prepared poly(4,4′-diphenylsulfonyl terephthalamide) is constituted by a mixture of a chain polymer and a cyclic component, as with the reaction solution A(1).

(i) The reaction solution C(4) was weighed and collected by 4000 mL and introduced into a round bottom flask, and the solvent was evaporated under reduced pressure with a rotary evaporator until a total amount of the reaction solution C(4) became 250 mL. To another flask, 750 mL of ion-exchange water was weighed and collected, and was mixed with the concentrated reaction solution C(4). The resulting mixture was deposited to obtain a composition (5). The deposited composition (5) was separated by a filtration operation to obtain 20 g of a composition (5). Note that, in the filtration operation, the solution remained after the deposition of the reaction solution C(4) was filtered once, and then 750 mL of ion-exchange water was added to the resulting composition (5) and filtration was carried out again. That is, filtration was carried out twice.

(j) The total amount (20 g) of the composition (5) was weighed and collected, and introduced into a flask. Further, 150 mL of a mixed solvent which was obtained by mixing THF and NMP in a volume ratio of THF:NMP=8:2 was added to the flask, and the resulting mixture was left to stand still for 17 hours to obtain a suspension. The suspension was stirred with a touch mixer for 1 minute, and filtration was carried out with a PTFE membrane filter having a pore diameter of 0.45 μm. Subsequently, THF and NMP were evaporated by vacuum-drying the filtrate, and 4.2 g of a powdery cyclic component (4) was obtained.

A contained amount of the cyclic component in the composition was measured in a manner similar to that in Example 1, except that the composition (4) was used instead of the composition (1). Subsequently, the powdery cyclic component (4) was added to the resin (4) having an amide bond so that the contained amount of the cyclic component was 4.0%, and thus a cyclic component-added solution (4) was prepared. A porous layer and a laminated separator were prepared, physical property values of the porous layer and the laminated separator were measured, initial charge-discharge efficiency was measured, and a contained amount of a cyclic component in the porous layer was measured in a manner similar to that in Example 1, except that the cyclic component-added solution (4) was used instead of the solution containing the resin (1) having an amide bond, and that the amount of NMP used was changed to 6.83 L and the amount of aluminum oxide used was changed to 280.0 g.

### Example 5

A reaction solution A(5) and a resin (2) that contained a block copolymer (5) in which the block A(5) accounted for 70% of the entirety of a molecule and the block B(5) accounted for the remaining 30% of the entirety of the molecule, that contained a cyclic component (5), and that had an amide bond were obtained in a manner similar to that in Example 1, except that the amount of NMP used in the step (a) was changed to 4208 g, the amount of calcium chloride used was changed to 365.92 g, the amount of DDS used in the step (c) was changed to 181.462 g, the total amount of TPC used in each of the steps (d) and (f) was changed to 210.276 g, the amount of PPD used in the step (f) was changed to 33.870 g, the concentration of calcium chloride in the solution of calcium chloride used was set to 8.0% by weight, and the water content in the solution of calcium chloride was adjusted to be 300 ppm. Note that, in Example 5, the weight of the block A(5) relative to the weight of the reaction solution A(5) was 6.02% by weight. In a manner similar to that in Example 1, 3.01 g of a composition (5) which was constituted by the block A(5) and the cyclic component (5) was obtained.

A contained amount of the cyclic component in the composition was measured in a manner similar to that in Example 1, except that the composition (5) was used instead of the composition (1). A porous layer and a laminated separator were prepared, physical property values of the porous layer and the laminated separator were measured, initial charge-discharge efficiency was measured, and a contained amount of a cyclic component in the porous layer was measured in a manner similar to that in Example 1, except that a solution containing the resin (5) having an amide bond was used instead of the solution containing the resin (1) having an amide bond, and that the amount of NMP used was changed to 6.83 L and the amount of aluminum oxide used was changed to 280.0 g.

### Comparative Example 1

<Preparation of Composition>

A solution containing a comparative polymer (1) and 3.0 g of a comparative composition (1) were obtained by a method which included the following steps (a′) through (e′).

(a′) A 5-L separable flask having a stirring blade, a thermometer, a nitrogen incurrent canal, and a powder addition port was sufficiently dried.

(b′) 4280 g of NMP was introduced into the flask. Further, 329.08 g of calcium chloride (which had been dried at 200° C. for 2 hours) was added, and a resulting mixture was heated to 100° C. The calcium chloride was completely dissolved to obtain a solution of calcium chloride. Here, in the solution of calcium chloride, a concentration of calcium chloride was 7.14% by weight, and a water content was adjusted to be 500 ppm.

(c′) To the solution of calcium chloride, 138.932 g of PPD was added while the temperature was maintained at 30±2° C., and the PPD was completely dissolved to obtain a comparative solution A.

(d′) The resulting comparative solution A was cooled to 20° C. After that, to the comparative solution A which had been cooled, a total of 251.499 g of terephthalic acid dichloride (TPC) was added in three separate portions while the temperature was maintained at 20±2° C. A reaction was then caused to occur for 1 hour, and a comparative reaction solution A was obtained.

(e′) While the temperature of the comparative reaction solution A was maintained at 20±2° C., the solution was matured for 1 hour. After that, the solution was stirred for 1 hour under reduced pressure, and air bubbles were removed. As a result, a solution containing a comparative polymer (1) constituted by poly(paraphenylene terephthalamide) was obtained. The comparative polymer (1) is mainly composed of a chain polymer. The comparative polymer (1) is a resin having an amide bond.

In another flask different from the separable flask, 0.5 L of ion-exchange water was introduced. Further, 50 mL of the solution containing the comparative polymer (1) was weighed and collected. After that, 50 mL of the collected solution containing the comparative polymer (1) was added to said another flask, and the comparative polymer (1) was deposited. The deposited comparative polymer (1) was separated by a filtration operation to obtain a comparative composition (1) which was constituted by 3 g of the comparative polymer (1). Note that, in the filtration operation, the solution remained after the deposition of the comparative polymer (1) was filtered once, and then 100 mL of ion-exchange water was added to the resulting deposit containing the cyclic component and filtration was carried out again. That is, filtration was carried out twice.

A contained amount of the cyclic component in the composition was measured in a manner similar to that in Example 1, except that the comparative composition (1) was used instead of the composition (1). A porous layer and a laminated separator were prepared, physical property values of the porous layer and the laminated separator were measured, initial charge-discharge efficiency was measured, and a contained amount of a cyclic component in the porous layer was measured in a manner similar to that in Example 1, except that a solution containing the comparative polymer (1) was used instead of the solution containing the block copolymer (1), and that the amount of NMP used was changed to 6.34 L and the amount of aluminum oxide used was changed to 240.0 g.

Table 1 below shows the contained amount of the cyclic component in the composition, the physical property values of the porous layer and the laminated separator, and the initial charge-discharge efficiency which were measured in each of Examples 1 through 5 and Comparative Example 1.

TABLE 1

| | | | | Laminated | Composition | Nonaqueous electrolyte |
|---|---|---|---|---|---|---|
| | Porous layer | | | separator | Contained amount | secondary battery |
| | | Weight per | Air | Weight per | of cyclic | Initial charge- |
| | Thickness | unit area | permeability | unit area | component | discharge efficiency |
| | [μm] | [g/m²] | [s/100 cc] | [g/m²] | [% by weight] | [%] |
| Example 1 | 12.9 | 1.8 | 288 | 7.88 | 2.8 | 84.2 |
| Example 2 | 12.6 | 1.7 | 274 | 7.75 | 2.7 | 84.6 |
| Example 3 | 12.6 | 1.7 | 268 | 7.71 | 3.9 | 85.5 |
| Example 4 | 12.7 | 1.6 | 215 | 8.08 | 4.1 | 85.7 |
| Example 5 | 12.6 | 1.5 | 206 | 7.77 | 3.3 | 85.8 |
| Comparative | 13.0 | 1.7 | 302 | 7.79 | 0.005 | 83.1 |
| Example 1 | | | | | | |

### CONCLUSION

In Examples 1 through 5 and Comparative Example 1, as a result of measuring the contained amount of the cyclic component in the porous layer, the contained amount of the cyclic component in the porous layer was not substantially changed from the contained amount of the cyclic component in the composition. Therefore, it has been found that, by using the composition in accordance with an embodiment of the present invention as a raw material, the porous layer in accordance with an embodiment of the present invention can be produced.

As indicated in Table 1, the initial charge-discharge efficiency of the nonaqueous electrolyte secondary battery including the porous layer described in each of Examples 1 through 5 is higher than the initial charge-discharge efficiency of the nonaqueous electrolyte secondary battery including the porous layer described in Comparative Example 1. Therefore, it has been found that the porous layer in accordance with an embodiment of the present invention can improve initial charge-discharge efficiency of a nonaqueous electrolyte secondary battery.

### INDUSTRIAL APPLICABILITY

The nonaqueous electrolyte secondary battery porous layer in accordance with an embodiment of the present invention can be suitably utilized as a member of a nonaqueous electrolyte secondary battery.

1. A nonaqueous electrolyte secondary battery composition comprising at least one type of a resin having an amide bond,
the resin having the amide bond containing a cyclic component, and
a contained amount of the cyclic component being not less than 2.0% by weight and not more than 10.0% by weight relative to a total weight of the resin having the amide bond.

2. A nonaqueous electrolyte secondary battery porous layer comprising at least one type of a resin having an amide bond,
the resin having the amide bond containing a cyclic component, and
a contained amount of the cyclic component being not less than 2.0% by weight and not more than 10.0% by weight relative to a total weight of the resin having the amide bond.

3. The nonaqueous electrolyte secondary battery porous layer as set forth in claim 2, wherein:
at least one type of the resin having the amide bond is a block copolymer including a block A containing, as a main component, units each represented by Formula (1) below, and a block B containing, as a main component, units each represented by Formula (2) below.
—(NH—Ar¹—NHCO—Ar²—CO)— Formula (1):
—(NH—Ar³—NHCO—Ar⁴—CO)— Formula (2):
where:
Ar¹, Ar², Ar³, and Ar⁴ may each vary from unit to unit;
Ar¹, Ar², Ar³, and Ar⁴ are each independently a divalent group having one or more aromatic rings;
not less than 50% of all Ar¹ each have a structure in which two aromatic rings are connected by a sulfonyl bond;
not more than 50% of all Ar³ each have a structure in which two aromatic rings are connected by a sulfonyl bond; and
10% to 70% of all Ar¹ and Ar³ each have a structure in which two aromatic rings are connected by a sulfonyl bond.

4. The nonaqueous electrolyte secondary battery porous layer as set forth in claim 2, further comprising a filler,
a contained amount of the filler being not less than 20% by weight and not more than 90% by weight relative to a total weight of the nonaqueous electrolyte secondary battery porous layer.

5. A nonaqueous electrolyte secondary battery laminated separator, wherein a nonaqueous electrolyte secondary battery porous layer recited in claim 2 is formed on one surface or both surfaces of a polyolefin porous film.

6. A nonaqueous electrolyte secondary battery member, comprising a positive electrode, a nonaqueous electrolyte secondary battery porous layer recited in claim 2, and a negative electrode which are disposed in this order.

7. A nonaqueous electrolyte secondary battery, comprising a nonaqueous electrolyte secondary battery porous layer recited in claim 2.

8. A nonaqueous electrolyte secondary battery member, comprising a positive electrode, a nonaqueous electrolyte secondary battery laminated separator recited in claim 5, and a negative electrode which are disposed in this order.

9. A nonaqueous electrolyte secondary battery comprising a nonaqueous electrolyte secondary battery laminated separator recited in claim 5.
